(19) United States
(12) Patent Application Publication
(10) Pub. No.: US 2006/0253527 A1
(43) Pub. Date: Nov. 9, 2006

(54) Method, terminal and device arragement for transferring a message to a terminal

(76) Inventor: Harri Kiljander, Espoo (FI)

Correspondence Address: HARRINGTON & SMITH, LLP, 4 RESEARCH DRIVE, SHELTON, CT, 06484-6212, US

(21) Appl. No.: 10/558,903

(22) PCT Filed: Jun. 24, 2004
(86) PCT No.: PCT/FI04/00385

§ 371 Date: Nov. 30, 2005

(30) Foreign Application Priority Data
Jun. 30, 2003 (FI) 20030981

(51) Int. Cl. G06F 15/16

(52) U.S. Cl. 709/203; 709/217

(57) ABSTRACT

The invention relates to a method, device arrangement and a terminal for transferring a message received in a first terminal in a controlled manner from said first terminal to a second terminal. In the method, the messages are searched for possible references to resources outside the message, and information is downloaded from these resources for later examination.

### FIELD OF THE INVENTION

The invention relates to a method for transferring a received message from a first terminal to a second terminal. The invention also relates to a system and terminals for transferring a received message from a first terminal to a second terminal. In particular, the invention relates to a system for transferring a received message to a mobile terminal and a mobile terminal that receives the message.

### BACKGROUND OF THE INVENTION

The use of e-mail has become an everyday habit, and the majority of people use e-mail both at work and during leisure time. In principle, the only requirements for using e-mail are a terminal with e-mail capability and a connection to an e-mail server. The conventional way of using e-mail is to use it at a personal computer, but nowadays there is a wide variety of mobile terminals, such as portable computers, handheld computers, such as Palm, PocketPC etc., and mobile stations, such as communicator-type devices with Internet capabilities.

If a mobile terminal provides a possibility to connect to the Internet using a GPRS connection or a WLAN connection, for example, it is generally also possible to use and read e-mail with it. However, the situation is not always this, and a device such as a portable computer or other terminal can be for various reasons unavailable for an Internet connection for part of the time or always. Then the terminal is in a so-called offline state, i.e. it does not have a connection to an external information net-work. In cases like this, such as when leaving one's workstation at the place of work, it may be possible to download the arrived e-mail messages from the personal computer to this portable terminal for later viewing. Such systems are well known in the art. For example the patent application US2002/0120696 discloses a method for synchronizing user-selected files, folders and folder hierarchies between a host system and a mobile data communication device.

However, the e-mail messages may have various links to addresses outside the actual message. Links like this include the URL or web addresses, which can be embedded in the text of the e-mail message as hyperlinks. These links may, for example, provide further information on the subject matter of the e-mail message, or the sender of the e-mail just wanted to inform the recipient of an interesting web page. However, when the e-mail messages have been downloaded to a terminal which is offline for reading them later, it is not possible to access the web addresses in the messages, because the terminal does not have a network connection.

In addition to e-mail, other types of messages can also contain references to sources outside the message. For example, in the MMS (Multimedia Messaging Service) messages used in mobile stations it is possible to send text, image and sound. MMS is an open industrial standard, and MMS messages can be transferred in the currently existing data networks and protocols. The MMS message itself is independent of the method of transmitting information, and the possibilities for using it are not limited to the most commonly used cellular networks, such as the GSM or WCDMA networks. An example of other types of messages is a push message, which is transmitted to a mobile terminal.

A Japanese patent document JP2002183059 A discloses a system wherein a user terminal, which can not connect to a web server, creates an e-mail containing a request to obtain information from the web server, and sends the e-mail to a proxy server. The proxy server analyzes the request written in the e-mail, connects to the requested web server and collects information from the web server. Then the proxy server packs the information into a file, attaches it to replying e-mail and sends the replying e-mail to the user terminal. Finally, the user terminal extracts the web information from the attached file of the replying e-mail and stores it into storage. In this solution the user specifies the URL's he wants to connect and the messages are sent in both directions between the user terminal and the proxy server.

It is an object of the invention to present a method for downloading the www-pages or other external resources shown by the hyperlinks in the received message for later examination or use.

### SUMMARY OF THE INVENTION

The objectives of the invention are achieved by a method and a system in which the received user's messages are searched for links to resources outside the message, and information is downloaded from these resources for later examination. The method, device arrangement and terminals according to the invention are characterized in what is set forth in the independent claims. Some preferred embodiments of the invention are described in the dependent claims.

The basic idea of the invention is the following: The content of the messages arriving at the first terminal is observed, and possible links to resources outside the message, such as URL addresses pointing to www-pages, are searched for from the messages. If such a reference or link is found from the message, the resource shown by the link is visited or its content is analysed. The resource shown by the link, such as a web page or a multimedia file, for example, can be downloaded to a computer into a cache, possibly reprocessed and transferred to a second terminal, such as a mobile terminal, in a controlled manner usually at the same time as the actual messages are downloaded or transmitted to it. The resource or information based on said resource may also be transferred at different time as the actual message or it may not be transferred at all, depending on the type of said information.

The invention provides the advantage that the outside resource to which reference was made in the sender's message is immediately available, even if the terminal does not have a connection to an external information network.

In addition, the invention provides the advantage that the need to connect to an external information network with a mobile terminal is reduced, and economic savings, for example, can thus be achieved.

Furthermore, the invention provides the advantage that by analysing the link in the message in advance it is possible to avoid a visit to a resource which is unnecessary or unwanted for the user, such as www-pages sent for advertising purposes.

Yet another advantage of the invention is saving the limited memory capacity of the mobile terminal by controlling the information transferred to it.

One aspect of the invention provides a method for transferring a message received in a first terminal in a controlled manner from said first terminal to a second terminal. In this method the message is searched for references to resources outside the message, and information is downloaded from these resources for later examination or use and optional transfer to said second device. Said information, parts of it or modified information may or may not be transferred to the second device. The decision of whether or not to transfer said information, and how to possibly modify it, to the second terminal may be done according to predefined rules or by other criteria in any of the terminals.

Another aspect of the invention provides a device arrangement for transferring a message received in a first terminal in a controlled manner from said first terminal to a second terminal by the method of the invention. The device arrangement comprises a first terminal, a second terminal and means for transferring information from the first terminal to a second terminal. The device arrangement also comprises means for searching the messages for references to resources outside the message, for downloading information from these resources for later examination and for optional transfer of said information to said second terminal.

Another aspect of the invention provides a first terminal comprising means for receiving a message and means for transferring said message in a controlled manner from said first terminal to a second terminal by the method of the invention. The terminal also comprises means for searching said message for references to resources outside the message, for downloading information from these resources for later examination and for optional transfer of said information to said second terminal.

Another aspect of the invention provides a second terminal, such as a mobile terminal, comprising means for receiving a message. Said terminal also comprises means for searching said received message for references to resources outside the messages by the method of the invention, for analysing the information in said referenced resources outside the message and for transferring said information to said terminal, and for making a decision on the processing of this information.

### BRIEF DESCRIPTION OF THE DRAWINGS

In the following, the invention will be described in more detail. Reference will be made to the accompanying drawings, in which

FIG. 1 shows a mobile terminal and a computer which is connected to an external information network,

FIG. 2 shows as a flow chart a method according to the invention, in which references to resources outside the message are searched for from the message, and

FIG. 3 shows, by way of example, modifying a web page with the method according to the invention.

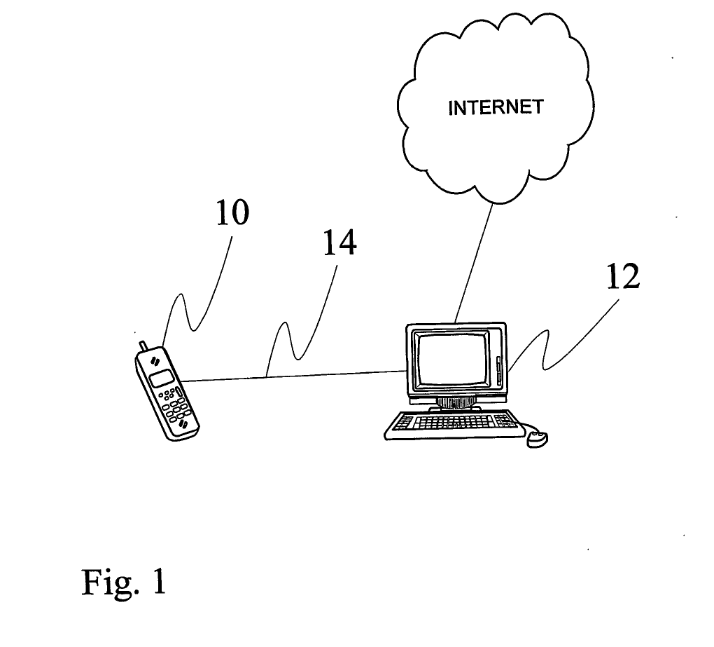

FIG. 1 shows a device arrangement according to the invention, in which there is a computer 12 as the first device and a mobile terminal 10 as the second device, and means 14 for transferring information from the computer 12 to the mobile terminal 10. The computer 12 which can receive the message is connected to an external information network, such as the Internet.

### DEFINITIONS

In this connection, the term “computer” means generally the first device from which e-mail is transferred to the mobile (second) terminal with the method according to the invention. The computer can be e.g. a personal computer of the PC or Macintosh type, and it has a capability to establish a connection to an external information network, such as the Internet. In general, such a computer is an immobile computer, such as a desktop PC or a Macintosh, but it can also be a portable computer or other terminal which is capable of handling e-mail and from which the e-mail can be transferred to a mobile terminal defined later with a method according to the invention. The “computer” can also be a similar mobile terminal as defined later. A “computer” can also be a server in an information network or a server that transmits or mediates multimedia messages, for example. The essential characteristic of the method according to the invention is the ability to transfer messages from a computer to another terminal using any suitable connection.

The term “terminal” used in this connection means any device that is capable of processing electronic information and is suitable for use in the method and device arrangement according to the invention. The terminal can be, for example, a computer, a PDA (Personal Digital Assistant) or a mobile phone of a cellular network. The terminal can be mobile or stationary. The terminal can also be a server, such as an e-mail server or a server of a cellular communication network, such as a server that transmits or mediates messages.

The term “mobile terminal” used in this connection means any terminal which can be moved and which can receive a message. With regard to e-mail, it is possible to use an e-mail application or read e-mail with the terminal, or e-mail can be transferred to it from the first device. Other types of messages that can be received by the terminal include an MMS message or a push message. Examples of such terminals are a portable computer or a PDA (Personal Digital Assistant), i.e. a handheld computer, which are based on the PalmOS, PocketPC, Windows CE, Symbian, BeOS or Linux operating systems, for example. Examples of devices like this include Nokia Communicator, Palm, Handspring and HandEra. In addition, many modern mobile phones include some features of a handheld computer, such as e-mail capability, in which case they are also covered by the definition. The terminal can also provide a possibility to establish a connection to an external information network, but it is not necessary. The terminal can also have characteristics of a mobile phone operating in a cellular network. With regard to the invention, it is essential that the terminal can be connected to the first device, from which information can be downloaded or transmitted to it, such as the user's e-mail or at least part thereof, or a multimedia message or a push message. This connection can be radio frequency, infrared or wired connection or any other suitable connection.

The term “transfer” in connection with the transfer of e-mail or other messages and the referred resources means an event in which information, such as e-mail or parts thereof is transferred or copied from an e-mail program or system or an associated cache memory of the first device to a second device, preferably the mobile terminal defined above. Copies of the e-mail messages can remain in the first device, or they can be removed from it in connection with the transfer event. A transfer event like this is generally also called synchronization, meaning that after the transfer the first and the second device will have similar or essentially similar files or e-mail messages and the information possibly referred by the message. However, when the method according to the invention is used, the messages will probably not be exactly similar in both devices, because the method can reduce or increase the amount and/or size of the information transferred to the second device. Methods and programs for transferring information from the first device to the second device are well known. For example, the PC Suite program of Nokia can be used for transferring information between a PC and a Nokia mobile phone. Any suitable program or a set of programs can be used for transferring information from the first device to the second device, depending on the equipment used. In connection with a multimedia message or a push message, “transfer” means an event in which information, such as a message, is transferred from the first, transmitting terminal to a second, receiving terminal. The information to be transferred can be information, which is modified from the original information at the external resource. The information to be transferred can also be information concerning the information in the external resource, such as information about its size and type. Information like this is necessary for estimating if the information in the external resource is suitable for transferring to the second terminal. In this connection, the term “external resource” means any resource that is outside the actual message, but to which reference is made in the message or its attachment. The reference may be in the form of a link, such as a hyperlink, and it can point to a web page, a news server, a file in the Internet or an intranet, such as a multimedia file, network disk, such as a shared disk of a company's information system or other resource or a streaming-type data flow, for example. The link can thus be e.g. an URL address, which refers to an address according to the http, https or ftp protocol, or an UNC path to a network resource. The link can refer to a web page, but it can also refer to a mere file which can be located in an address according to the http, https, ftp or other suitable protocol. The file can be an image file, sound file, video file, text file, pdf file, compressed file, program file or any other file. The link can also refer to a data flow or a generable page or pages, such as a service or page implemented with the php language or like. The protocol used can also be any other suitable protocol, such as some other protocol used in the Internet or in a local area network.

The term “message” used herein means any message sent by sender, such as e-mail, multimedia message, push message or any other suitable message. Preferably the message is received by the first terminal.

The term “e-mail” means any e-mail according to any known e-mail system. The e-mail server can operate in any known operating environment, and it can use any known protocol. The user can have a client program that is suitable for using and reading e-mail, or the e-mail can be read by means of a browser-based user interface, for example. Examples of known e-mail client programs are, but are not limited to: Outlook, Outlook Express, Eudora, Netscape Mail, Pegasus Mail, Lotus and Teamware Mail.

The term “multimedia message” means any type of message that supports multiple content, used in a cellular network system. An example of a multimedia message is the MMS message. Although the most common way to transfer a multimedia message is to transmit it from the first terminal to the second terminal, the actual message can also be transferred by using other methods.

The term “push message” means any message used in the cellular network system, in which selected information is automatically transferred to the user. The push technique is used e.g. in services in which the operator transmits news or other selected information, such as sports results, to the client's mobile phone.

The term “compressing” means any known method for compressing information, in which the purpose of the method is to reduce the original size of the information. The compression can be lossless or lossy. In lossless compression, all the original information is retained, although the information is compressed into a smaller size. Some examples of known lossless compression methods are the zip, rar and Ihz methods. The gif or png types used in image files, for example, are packed in a lossless manner, such as the gif image with the Ihz algorithm. In lossy compression, some information is lost from the original. When lossy compression is used, it is generally attempted to carry it out in such a way that the lost pieces of information would be such that they are not easily detected among the other information, whereby the quality of the original information would not suffer very much. Lossy compression methods are generally used in multimedia files, such as image, sound and video files, in which it is usually possible to select the compression rate. This means compromising between the size of the file and the quality of information. Various compression methods and algorithms are generally known in the art.

### DETAILED DESCRIPTION OF THE INVENTION

In the method according to the invention, the incoming messages to the first device are monitored automatically and references to outside resources are searched for from them. The system that monitors the messages can be, for example, built in the e-mail client program or it can be a separate program or a plugin. It can also operate in an e-mail or other server, for example, or in a mobile terminal according to one embodiment. The system that monitors the messages may operate in the first device, such as a computer, to which the e-mail messages are generally downloaded in normal use. The system that monitors the messages can also operate in some other device, such as a terminal transmitting a multimedia message, a network transmitting a message, a server operating in it or some other terminal. The method used by this system is characterized in that the reference in the message, preferably a hyperlink, is recognized from the actual received message, generally text, and it is analysed or the address shown by it is visited. The external resource to which reference was made in the message may be downloaded to the cache of the first device, from which it can be processed further. In a case in which the reference in the message refers to an address which is defined as to be ignored, such as certain addresses known from advertising purposes, it is not necessary to download the external resource to the cache or even visit the address.

Because the referenced outside resource is meant to be possibly transferred or copied later to a mobile terminal, which may have a limited memory or saving capacity, it is necessary to analyse the properties of the external resource or file it refers, such as its size. It may be impossible to make a large file or a set of www-pages to fit in the memory of the terminal, or it would take space from other information. In that case, it may be necessary to remove some extra elements, such as images of the www-pages, or advertising banners. The content and size of the images can be analysed, and they can be e.g. reduced or recompressed using a larger compression rate, whereby they take less space or fit better on the display of a small-sized terminal, for example. In addition, reducing the number of colours in the images or multimedia can reduce the file size.

Furthermore, various rules can be applied in connection with the analysis of the outside resources, such as ignoring the elements in certain addresses. This may be necessary to avoid material sent for advertising purposes, for example. Likewise, messages coming from certain addresses can be totally ignored. The recognition of elements of a certain shape and/or located in a certain place can help to reduce so-called advertising banners, for example. The rules for handling outside resources can be preferably defined individually, taking into account matters like the properties of the mobile device, such as memory capacity, display resolution or sound properties, or taking into account the user's own preferences and definitions of acceptable and not acceptable web addresses, for example. The arrangement according to the invention can handle outside resources fully automatically or it can, for example, check the user's approval for a certain procedure to be carried out, such as whether a certain image or web page may be transferred to the mobile device for later viewing.

It is possible to specify limit values for the information in the external resource concerning the size, type and quality, and when these values are exceeded, the information is processed again, i.e. a decision is taken on whether to transfer information to the second device as such, as modified or not transferred at all. Size means the size of the information or the file in bytes, the type means the file type, such as whether it is an image, sound, video, text, program or some other file. Quality can mean the relative quality of the information saved in the file, like the resolution, compression rate or number of colours of an image or video file. The limit values specified for these mean predetermined values that are compared to the current piece of information; on the basis of this a decision is taken on reprocessing the information.

According to one embodiment, size limits can be set to the images and other files, in which case e.g. images or files that exceed a certain limit are not downloaded, or images, sound files or multimedia files that exceed a certain limit are recompressed to achieve a smaller file size. Types of image files that are generally used include, for example, the bitmap types JPEG (JPG), GIF, BMP, PNG, WBMP, or TIFF, but any other type of image, such as image types containing bitmap or vector graphics, or subtypes of these, can be applied. For example, the compression rate of an image of the JPG type is lossy, and it can be adjusted programmatically, leaving out small details and thus achieving a smaller file size. According to a preferred embodiment, the image can be saved as a different type of image, thus achieving a smaller file size. For example, BMP or TIFF files can be large, because lossy compression is not used in them. However, these image types can be recompressed using a lossy method, such as JPEG, whereby a substantially smaller file size is obtained, with some compromise in quality. In many cases this does not cause much inconvenience, because a mobile terminal may be equipped with a small display on which the deterioration in the image quality is not distinguished. When the file type is changed in connection with reprocessing, the reference to the file in the mobile message must also be changed to correspond to this new file type. The image resolution in pixels can also be reduced, the result being a smaller file and a smaller image size, which can fit on the small display of the terminal better. The number of colours contained by the images can also be reduced in order to reduce the file size. Methods for the above mentioned various reprocessing of images are well known.

Similar recompressing and resolution changing methods can also be applied e.g. to multimedia files, such as sound or video files. For example, a sound file can be a compressed sound file, such as an MP3 file, or an uncompressed sound file, such as a sound file of the WAV form. Like in the previous example, a compressed or uncompressed sound file can be recompressed with a lossy method, such as the MP3 or WMA algorithm, whereby a higher compression rate or lower sampling frequency than in the original is used, for example. The number of channels of the original sound signal can also be reduced, from stereo to mono, for example. Recompression and/or reducing the image resolution can also be applied to video files. For example, video or multimedia clips of the AVI, WMV, MOV, RealMedia, RealVideo or MPG type can be recompressed with a higher compression ratio according to the above described principle. The new quality of the files that are recompressed or processed in other ways may be adjusted according to the capabilities of the mobile terminal used, such as the size of the display or its sound properties.

Methods for the reprocessing of multimedia files like those mentioned above are well known.

According to an embodiment, the system according to the invention recognizes—on the basis of predetermined parameters associated with the form, place or web address—e.g. an image element on a web page as an advertising image, or a so-called banner. Elements like this are often on the top or bottom edge of the image, and their shape is often longer in the horizontal direction than in the vertical direction.

Sometimes they also include animations. An image like this can also include an external web address, which e.g. points to the advertiser's own www-pages or some other outside address, or the image itself can be downloaded from an address outside the web page containing it. Other types of advertising images also exist. Methods for recognizing such advertising banners are well known in the field.

According to one embodiment, the system according to the invention checks that the resource being moved or processed has not already been moved as such or moved as processed to the mobile terminal. Wasting the memory capacity of the terminal with duplicated files is thus avoided.

Finally, the downloaded and possibly reprocessed files and pages can be downloaded to the terminal for later viewing in connection with downloading e-mail.

According to yet another embodiment, the second terminal itself monitors the arriving messages and analyses the references to outside resources contained by them.

Because in this case it is not practical for the second terminal to transfer all the information indicated in the external resource to its own memory, it checks the resource indicated by the reference at first, analyses its content and acts accordingly.

For example, files of a certain type that exceed a certain predetermined size are then 30 not transferred to the second terminal. On the other hand, files of a certain type that fall below a certain predetermined size can be transferred, for example image files of a certain type. In addition, some files can be compressed when they are transferred, whereby they may fit in the memory of the second terminal. Likewise, resources located in certain addresses or otherwise referring to them, as well as recognized advertising banners can be left untransferred.

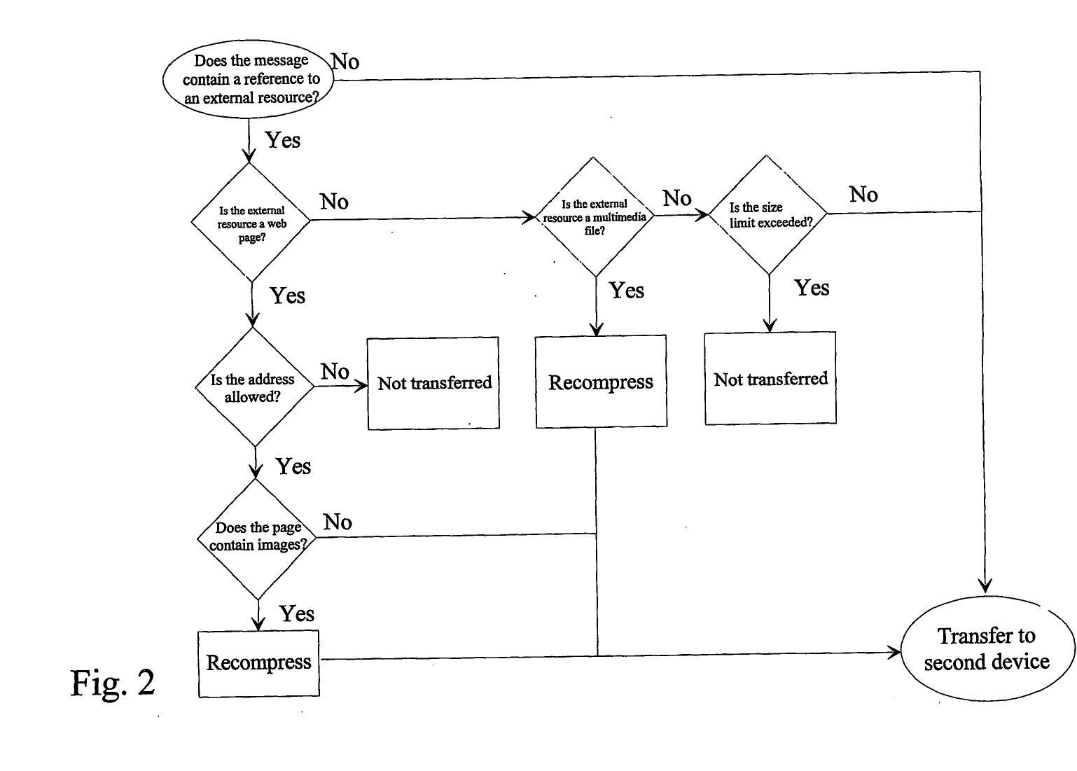

FIG. 2 is a flow chart showing some steps of an embodiment of the method according to the invention. At first it is checked whether the message contains references to resources outside the message. If it contains them, it is checked whether the referenced outside resource is a web page. If it is, it is checked whether the address of that web page is on the list of allowed addresses. If it is, the structure of the page can be analysed and it can be checked if there are images on the page, for example. If there are images, and preferably if they exceed the specified size limit, they are recompressed. Finally, the page with its images is transferred to the mobile terminal. The same procedure is followed if the external resource comprises a multimedia file, such as an image, sound or video file. Then the file can be recompressed to reduce its size. The file can also be ignored, if its size exceeds the set limit values or it is other than a multimedia file.

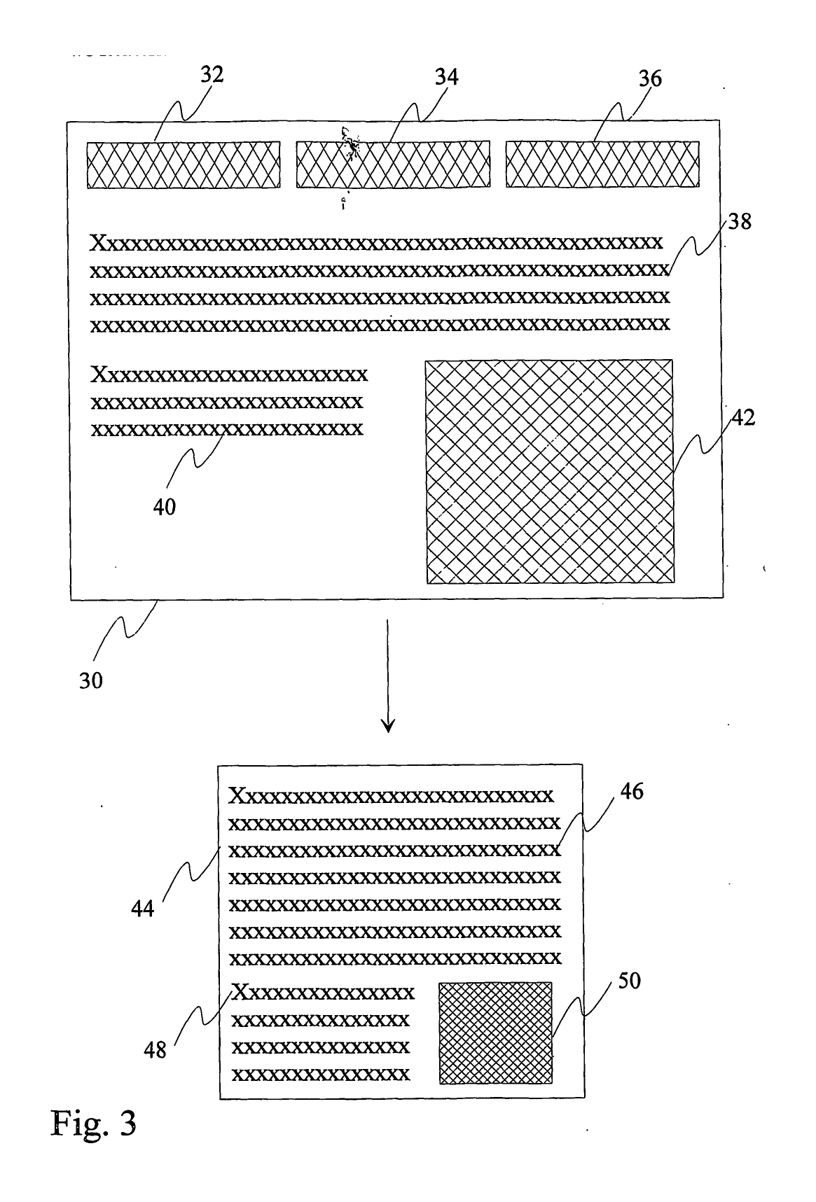

FIG. 3 shows, by way of example, a situation in which a method according to the invention is used to analyse and process a web page for transferring it to a mobile terminal. In the upper part of the figure there is a web page 30, which includes various elements, such as advertising banners 32, 34 and 36, text 38 and 40, and a large image 42. Because the purpose is to transfer the web page into a Palm-type PDA device with a display of 320×320 pixels, the web page must be modified to make it fit on a small display better. This is done in the following way, for example: The system according to the invention recognizes the advertising banners 32, 34 and 36 in the upper part of the web page, and removes them and the hyperlinks connected to them. FIG. 42, which is an image of the jpeg type, sized 140 kilobytes, is reprocessed, whereby the number of its colours are reduced from 16 million to 256 colours, its size is reduced from 500×500 pixels to 150×150 pixels, and finally it is compressed by using a large, 50 per cent jpeg compression rate, whereby a file of ca. 5 kilobytes 50 is obtained. The text elements 48 and 40 are transferred as such. The processed web page 44 obtained as the end result contains the text elements 46 and 48 and a reprocessed image 50.

Some solutions according to the invention for transferring a message to a mobile terminal have been described above.

The invention is not limited to the solutions described above. For example, some file types not mentioned above can be reprocessed in accordance with the principles discussed above for obtaining a similar result. The inventive idea can be applied in many different ways within the scope defined by the attached claims.

1. A method for transferring a message received in a first terminal in a controlled manner from said first terminal to a second terminal, characterized in that the message is searched for references to resources outside the message, and information is downloaded from these resources for later examination and optional transfer to said second device.

2. The method according to claim 1, characterized in that information from external resources is transferred to the first terminal.

3. The method according to claim 1, characterized in that information from external resources is transferred to the second terminal.

4. The method according to claim 1, characterized in that the message is an email message, a multimedia message or a push message.

5. The method according to claim 1, characterized in that limit values concerning the size, quality and/or type of information have been set for information downloaded from a resource outside the message, and when these limit values are exceeded, the information is reprocessed.

6. The method according to claim 1, characterized in that the second terminal is a mobile terminal.

7. The method according to claim 6, characterized in that said first terminal is a personal computer.

8. The method according to claim 6, characterized in that said mobile terminal is a PDA (Personal Digital Assistant), a terminal of a cellular network or a portable computer.

9. The method according to claim 1, characterized in that said resources outside the message are www-pages, files or data flow outside the message.

10. The method according to claim 9, characterized in that said files outside the message are multimedia files.

11. The method according to claim 10, characterized in that said multimedia files are jpeg, gif, tiff, bmp, png, wbmp, mp3, wma, wav, avi, wmv, mpeg, RealMedia, RealVideo or mov files.

12. The method according to claim 5, characterized in that when said preset limit values concerning the size, quality and/or type of information are exceeded, the information is not transferred to the terminal.

13. The method according to claim 5, characterized in that when said preset limit values concerning the size, quality and/or type of information are exceeded, the information is reprocessed so that its size is reduced.

14. The method according to claim 13, characterized in that said information is processed by recompressing it.

15. The method according to claim 12, characterized in that said information comprises an image file, a video file or other multimedia file, which is recompressed with a lossy compression method, by reducing the number of colours or by reducing the resolution.

16. The method according to claim 1, characterized in that a comparison is carried out to check whether a corresponding piece of information has already been saved in said second terminal.

17. The method according to claim 16, characterized in that if a corresponding piece of information has already been saved in said second terminal, it will not be transferred to said second terminal.

18. The method according to claim 9, characterized in that an image element recognized from said web page on the basis of predefined parameters related to form, location or web address is not transferred to said second terminal.

19. A device arrangement for transferring, a message received in a first terminal in a controlled manner from said first terminal to a second terminal, the device arrangement comprising a first terminal, a second terminal and means for transferring information from the first terminal to a second terminal, characterized in that the device arrangement also comprises means for searching the messages for references to resources outside the message, for downloading information from these resources for later examination and for optional transferring of said information to said second terminal.

20. The device arrangement according to claim 19, characterized in that the device arrangement comprises means for transferring information from the referenced resources outside the message to the first terminal.

21. The device arrangement according to claim 19, characterized in that the device arrangement comprises means for transferring information from the referenced resources outside the message to the second terminal.

22. The device arrangement according to claim 19, characterized in that said second terminal is arranged to analyse information about the referenced resources outside the message and to decide on the information processing on the basis of this.

23. The device arrangement according to claim 22, characterized in that said second terminal is arranged not to transfer files of a certain predefined type that exceed a certain predefined size into its memory.

24. The device arrangement according to claim 22, characterized in that said second terminal is arranged to compress files of a certain predefined type that exceed a certain predefined size in connection with transferring to said second terminal.

25. The device arrangement according to claim 19, characterized in that said second terminal is a mobile terminal.

26. A first terminal comprising means for receiving a message and means for transferring said message in a controlled manner from said first terminal to a second terminal, characterized in that the terminal also comprises means for searching said message for references to resources outside the message, for downloading information from these resources for later examination and for optional transfer of said information to said second terminal.

27. The terminal according to claim 26, characterized in that the device arrangement comprises means for transferring information from the referenced resources outside the message to the first terminal.

28. The terminal according to claim 26, characterized in that the device arrangement comprises means for transferring information from the referenced resources outside the message to the second terminal.

29. A mobile terminal comprising means for receiving a message, characterized in that the terminal also comprises means for searching the received messages for references to resources outside the messages, for analysing the information in said referenced resources outside the message and for transferring said information to said terminal, and for making a decision on the processing of this information.

30. The terminal according to claim 29, characterized in that the terminal is arranged not to transfer files of a certain type that exceed a certain predefined size into its memory.

31. The terminal according to claim 29, characterized in that limit values concerning the size, quality and/or type of information have been set far the information in the referenced resource outside the message, and when these limit values are exceeded, the information is arranged to be reprocessed.

32. The terminal according to claim 31, characterized in that the terminal is arranged to compress files of a certain type that exceed a certain predefined size in connection with transferring to the terminal.
